(19) United States
(12) Patent Application Publication
(10) Pub. No.: US 2022/0116267 A1
(43) Pub. Date: Apr. 14, 2022

(54) FAULT RECOVERY CONTROL METHOD, COMMUNICATION APPARATUS, COMMUNICATION SYSTEM, AND PROGRAM

(71) Applicant: NEC CORPORATION, Minato-ku, Tokyo (JP)

(72) Inventor: Yusuke TADA, Tokyo (JP)

(73) Assignee: NEC CORPORATION, Minato-ku, Tokyo (JP)

(21) Appl. No.: 17/266,750

(22) PCT Filed: Aug. 8, 2019
(86) PCT No.: PCT/JP2019/031353

§ 371 Date: Feb. 8, 2021

(30) Foreign Application Priority Data
Aug. 10, 2018 (JP) 2018-151993

(51) Int. Cl. H04L 41/0659; H04L 41/5025; H04L 45/28

(52) U.S. Cl. CPC H04L 41/0659; H04L 45/28; H04L 41/5025

(57) ABSTRACT

Provided is a fault recovery control method for a communication apparatus arranged in a site and including virtual network functions used for service chaining, the method including: having, at least a part of functions of an upper apparatus for changing the service chaining on the communication apparatus in the site, deployed on the communication apparatus in the site, wherein the upper apparatus manages the virtual network functions and the service chaining on the communication apparatus; and on occurrence of a fault in the communication apparatus in the site, the communication apparatus rearranging autonomously the service chaining thereon to perform recovery from the fault.

### REFERENCE TO RELATED APPLICATION

The present invention is based upon and claims the benefit of the priority of Japanese patent application No. 2018-151993, filed on Aug. 10, 2018, the disclosure of which is incorporated herein in its entirety by reference thereto.

The present invention relates to a fault recovery control method, a communication apparatus, a communication system, and a program.

### BACKGROUND

With advancement of virtualization technology Software-Defined Networking (SDN), a method for constructing a network and providing a service therethrough is changing dramatically. As an example, unlike conventional network construction and service provision using a hardware-based network appliance(s), network functions are now separated from hardware and executed as software image(s) on general-purpose hardware using virtualization technology. In addition, these software-based network functions can be integrally managed by an SDN controller. As a result, overall operating costs can be reduced and a quick response to change in service demand, for example, can be achieved.

While software-based network functions can be controlled from a host device such as an SDN controller, special orchestration functions are required when providing a service using multiple Virtual Network Functions (VNFs), such as Universal Customer Premises Equipment (uCPE) described below. As is well known, regarding network function virtualization (NFV), NFV standardization organization ETSI (European Telecommunications Standards Institute) considers an architecture which is divided into three functional layers, i.e., virtualized infrastructure management (Virtualized Infrastructure Manager, VIM), VNF management (Virtual Network Function Manager, VNFM), and orchestration (NFV orchestrater).

The following describes a uCPE, which is one use case of virtualization technology. FIG. 9 is a diagram schematically illustrating an example of a typical system configuration of a uCPE system. As illustrated in FIG. 9, network functions of Customer Premises Equipment (CPE) are virtualized, and a plurality of virtual network functions (VNFs) are implemented on hardware (also referred to as “a uCPE apparatus” or “a uCPE terminal”) 100A and 100B deployed in sites (enterprise branch sites) 10A and 10B. The uCPE apparatuses 100A and 100B are connected to server groups 101A and 101B, respectively, in the sites via a LAN (local area network).

The individual sites 10A and 10B are connected to a data center 20 (cloud) via a wide area network (WAN) 30. For example, the WAN 30 may be the Internet, MPLS (Multi-Protocol Label Switching), or the like. The WAN 30 may be configured as a Software-Defined (SD)-WAN.

Upper apparatuses such as an orchestrator 202 and a VNF controller 203 are deployed in the data center 20. For example, the orchestrator 202 is configured as an orchestrator (NFV Orchestrator) in NFV MANO (Network Functions Virtualization Management and Network Orchestration). For example, the orchestrator (NFV Orchestrator) 202 performs lifecycle management (instantiation, monitoring, operation, removal, etc.) of network services configured by a plurality of VNFs and is in charge of integrated operation and management of an entire system.

VNF controller 203 performs VNF management (VNF Manager: VNFM). The VNFM is in charge of VNF configuration, lifecycle management, and element management. In lifecycle management of an individual VNF, a VNF descriptor (VNFD) is used, which is a template including description of a VNF regarding deployment and operation requirement, etc.

When the sites A and B are not distinguished from each other, either the uCPE apparatuses 100A or 100B will be referred to as a uCPE apparatus 100 with a reference character A or B omitted. The individual uCPE apparatus 100 includes an NFV Infrastructure (Network Functions Virtualization Infrastructure: NFVI) that provides a virtual machine execution infrastructure for VNFs. For example, the NFVI provides a virtualization layer such as a hypervisor and computing, storage, and networking hardware components for hosting a VNF(s). Control of resources (physical resources and virtual resources) and lifecycle management of the computing, storage, and network of the NFVI are performed via a Virtualized Infrastructure Manager (VIM) in NFV MANO. The VIM may be provided in uCPE apparatuses 100A and 100B, for example.

Service chaining is a mechanism in which various network functions such as a router, a firewall, and a load balancer are coordinated with each other and packets are exchanged in an appropriate order. Various network services can be provided to customers (users) at individual sites by operating a plurality of VNFs on the NFVIs of the uCPE apparatuses 100 and connecting VNFs with service chaining.

To implement such service chaining among VNFs on the individual uCPE apparatus 100, the data center 20 includes a controller (uCPE-PF (platform) controller) 201 that sets/controls a path(s) inside a hardware platform, a controller group (VNF controller) 203 that sets/controls the VNFs at individual sites, and the orchestrator 202 that coordinates individual controllers and provides final network services. Generally, the upper apparatus group such as the uCPE-PF controller 201, the VNF 203, and the orchestrator 202 are deployed in the data center 20.

While not particularly limited, IN FIG. 9, one of the network functions virtualized as VNFs implemented on a uCPE apparatus 100 may be a virtual firewall, IPS (intrusion prevention system), virtual router, VPN (Virtual Private Network)/NAT (Network Address Translation), virtual switch, load balancer, SD-WAN (software-defined wide area network), WAN speed-up apparatus, or the like.

In FIG. 9, for simplicity, the uCPE apparatuses 100A and 100B each perform service chaining with two VNFs. However, the number of VNFs is as a matter of course not limited to two. A plurality of VNFs are connected to each other via a virtual link(s) (VL(s)). Among the VLs, an external virtual link is a logical link that provides connection between CPs (Connection Points) of external interfaces of VNFs or between a CP of a VNF and a CP serving as a network service end point, for example. An internal virtual link is a logical link inside a VNF and provides connection between a CP of a VNFC (Virtual Network Function Component) and a CP serving as an external interface of the VNF. The individual virtual link (VL) is defined by, for example, a VLD (Virtual Link Descriptor), which is a template in which resource requirements of logical links that provide connection between VNFs and between PNFs (Physical Network Functions) that constitute network services are described.

In the uCPE system, the uCPE apparatus 100 which includes a plurality of VNFs, is deployed in each site 10. A group of upper apparatuses, such as a controller and an orchestrator, which control a plurality of VNFs and VNF service chains on the uCPE apparatus 100, are deployed in the data center 20.

Thus, for example, in a case of customers (users), such as global companies expanding their businesses globally, the site 10 and the data center 20 could be far away from each other by, for example, several tens of thousands of kilometers. In this case, a problem of a transmission delay between the site 10 and the data center 20 becomes apparent. For example, regarding an intra-network delay time or the like, SLA (Service Level Agreement) or the kike is affected.

Regarding service chaining, the orchestrator 202 in the data center 20 grasps an overall system and transmits an instruction (referred to as “a first control signal”) to the uCPE-PF controller 201 and the VNF controller 203 in response to a network service request from a customer (user).

On reception of the instruction, the uCPE-PF controller 201 and the VNF controller 203 transmit a control signal (referred to as “a second control signal”) to the corresponding uCPE apparatus 100 in the user site to control the uCPE apparatus 100. In this way, control across a plurality of control planes is performed until the service chaining is configured in the uCPE apparatus 100.

Depending on processing capability and load status of the upper apparatus (orchestrator 202, uCPE-PF controller 201, and VNF controller 203), a delay is caused until the second control signal reaches the uCPE apparatus 100 from the uCPE-PF controller 201 and the VNF controller 203. When the first control signal from the orchestrator 202 to the uCPE-PF controller 201 and the VNF controller 203, and the second control signal from the uCPE-PF controller 201 and the VNF controller 203 to the uCPE apparatus 100 are respectively delayed, time is needed from occurrence of a fault in the uCPE apparatus 100 to recovery from the fault.

In FIG. 9, a dashed arrow from a uCPE apparatus 100 schematically indicates a path from occurrence of a fault in the uCPE apparatus 100 to transmission of a control signal from the orchestrator 202 to the uCPE apparatus 100 via the uCPE-PF controller 201 and the VNF controller 203. When there is a time delay from occurrence of a fault in a uCPE apparatus 100 to recovery from the fault, deterioration of a service level, e.g., unacceptable service down-time, etc., could be generated.

Patent Literature (PTL) 1 discloses that a large impact is caused when a control apparatus, which concentratively controls virtualized network service functions, malfunctions and there is a problem on availability of a virtualized network service function. According to PTL 1, to address this problem, each apparatus in a service chaining system autonomously performs alive monitoring, fault detection and fault recovery of a link between apparatuses, and fault detection and fault recovery of a link of each apparatus in a decentralized manner. In addition, in the service chaining system, SCF (Service Chaining Forwarder) apparatuses autonomously perform mutual exchange of service function statement advertisement information for enabling service chaining among individual apparatuses in a distributed manner. In addition, each SCF apparatus refers to a topology information table managed thereby and appropriately selects a forwarding destination SF (Service Function) based on “resource information” and “a total cost value”. As described above, according to PTL 1, the SCF apparatuses need to perform mutual exchange of the service function statement advertisement information for enabling service chaining among the individual apparatuses.

### CITATION LIST

### Patent Literature

PTL 1: Japanese Unexamined Patent Application Publication No. 2016-46736

### SUMMARY

### Technical Problem

As described above, in a uCPE system, when a fault occurs in a VNF or the like on a uCPE apparatus deployed at a site,
an upper apparatus (an orchestrator, a controller, or the like) in a data center grasps the fault,
a control signal is transmitted from the upper apparatus in the data center to the uCPE apparatus deployed in the site, and
the uCPE apparatus performs recovery processing based on the control signal.

Thus, as a result of a delay of time from occurrence of a fault in the uCPE apparatus to recovery from the fault, deterioration of the service level, e.g., unacceptable service down-time, etc., might occur.

The present invention has been made in view of the above problem, and it is an object of the present invention to provide a fault recovery control method, a communication apparatus, a communication system, a program, and a recording medium, each enabling to reduce fault recovery time of service chaining.

### Solution to Problem

According to one aspect of the present invention, there is provided a fault recovery control method for a communication apparatus in a communication system, wherein the communication system includes: the communication apparatus that is arranged in a site and includes a plurality of virtual network functions used for service chaining; and at least one upper apparatus that is connected to the communication apparatus in the site via a network and manages the virtual network functions and the service chaining on the communication apparatus. The method includes:

setting, at least a part of functions of the upper apparatus for changing the service chaining on the communication apparatus in the site, to be deployed on the communication apparatus in the site; and

on occurrence of a fault in the communication apparatus in the site, the communication apparatus rearranging autonomously the service chaining thereon to perform recovery from the fault.

According to one aspect of the present invention, there is provided a communication system including: a communication apparatus arranged in a site, the communication apparatus including a plurality of virtual network functions and a service chaining with the virtual network functions connected; and at least one upper apparatus connected to the communication apparatus via a network, the upper apparatus managing the virtual network functions and the service chaining on the communication apparatus. The communication apparatus includes a control part that changes the service chaining on the communication apparatus, wherein the control part of communication apparatus, on occurrence of a fault in the communication apparatus, rearranges the service chaining to perform recovery from the fault.

According to one aspect of the present invention, there is provided a communication apparatus arranged in a site and including a plurality of virtual network functions and service chaining with the virtual network functions connected, wherein the communication apparatus is connected to at least one upper apparatus that manages the virtual network functions and the service chaining on the communication apparatus via a network. The communication apparatus includes: a storage part that stores setting information about the service chaining connecting the virtual network functions; and a control part that, on occurrence of a fault, changes the service chaining, based on the setting information stored in the storage part to perform recovery from the fault.

According to one aspect of the present invention, there is provided a program, causing a computer that constitutes a communication apparatus that is arranged in a site, includes a plurality of virtual network functions and service chaining with the virtual network functions connected, and that is connected to at least one upper apparatus that manages the virtual network functions and the service chaining on the communication apparatus via a network, to execute processing including:

storing setting information about the service chaining connecting the virtual network functions in a storage part; and

on occurrence of a fault, changing the service chaining, based on the setting information stored in the storage part to perform recovery from the fault.

According to another mode of the present invention, there is provided a computer-readable recording medium storing a program, causing a computer that constitutes a communication apparatus that is arranged in a site, includes a plurality of virtual network functions and service chaining with the virtual network functions connected, and that is connected to at least one upper apparatus that manages the virtual network functions and the service chaining on the communication apparatus via a network, to execute processing including:

storing setting information about the service chaining connecting the virtual network functions in a storage part; and

on occurrence of a fault, changing the service chaining, based on the setting information stored in the storage part to perform recovery from the fault. For example, the recording medium is provided as a non-transitory computer-readable recording medium such as a semiconductor storage such as a RAM (Random Access Memory), a ROM (Read-Only Memory), or an EEPROM (Electrically Erasable and Programmable ROM), an HDD (Hard Disk Drive), a CD (Compact Disc), or a DVD (Digital Versatile Disc).

### Advantageous Effects of Invention

According to the present invention, the fault recovery time of service chaining can be reduced.

### BRIEF DESCRIPTION OF THE DRAWINGS

FIG. 1 is a diagram illustrating an example embodiment of the present invention.

FIG. 2 is a diagram illustrating the example embodiment of the present invention.

FIG. 3 is a diagram illustrating a configuration according to the example embodiment of the present invention.

FIG. 4 is a diagram illustrating a configuration (a site management part) according to the example embodiment of the present invention.

FIG. 5 is a flowchart illustrating an operation according to the example embodiment of the present invention.

FIG. 6 is a flowchart illustrating an operation according to the example embodiment of the present invention.

FIG. 7 is a flowchart illustrating an operation according to the example embodiment of the present invention.

FIG. 8 is a diagram illustrating a configuration according to an example embodiment of the present invention.

FIG. 9 is a diagram illustrating a related technique.

### DESCRIPTION OF EMBODIMENTS

According to one of embodiments of the present invention, a service chaining change function, which is originally performed by an upper apparatus such as an orchestrator (NFV Orchestrator) on occurrence of a fault, is deployed in an individual uCPE apparatus in an individual site. When a fault occurs, the uCPE apparatus autonomously performs fault recovery processing by changing a corresponding service chaining for recover from the fault in the uCPE apparatus, without waiting for an instruction from the upper apparatus such as the orchestrator. Thus, while time is conventionally needed from occurrence of a fault to recovery from the fault, the prevent invention can shorten the time needed to change the service chaining. That is, the prevent invention can reduce fault recovery time.

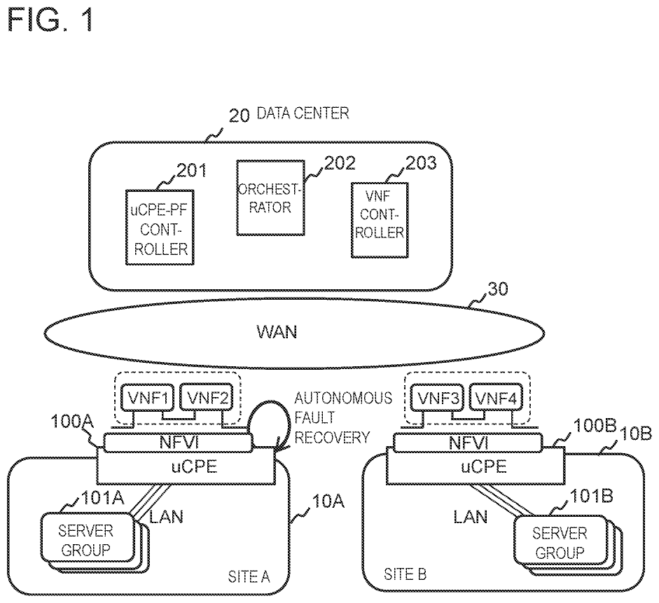

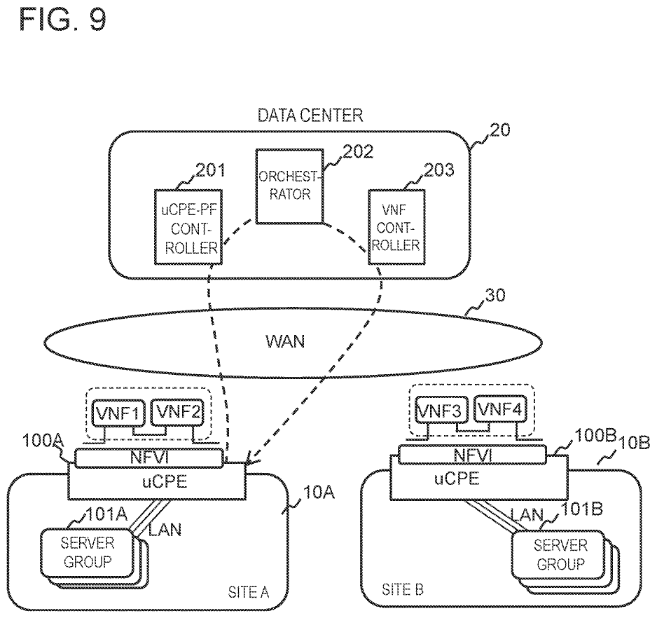

FIG. 1 is a diagram illustrating an example embodiment of the present invention. FIG. 1 is a diagram schematically illustrating a difference between the typical uCPE system illustrated in FIG. 9 and an example embodiment. Since FIG. 1, is a diagram illustrating an example embodiment of the present invention in comparison with the comparative example in FIG. 9, it should not as a matter of course be interpreted that the present invention is limited to the configuration in FIG. l. For example, the number of sites is not as a matter of course limited to 2, and the number of VNFs on an individual uCPE apparatus is not of course limited to 2. Hereinafter, regarding the uCPE apparatus 100, the WAN 30, the data center 20, etc., the same description as that has been made with reference to FIG. 9 will be omitted as needed to avoid redundancy, and the difference will be described.

In FIG. 1, the individual uCPE apparatus 100 includes a storage part (not illustrated) in which configuration information about VNFs that operate on the NFVI of the uCPE apparatus 100 and setting information about internal paths of service chaining. With fault information as a trigger, the uCPE apparatus 100 performs fault recovery processing by rearranging the service chaining, for example. The uCPE apparatus 100 mediates control signals about various kinds of setting information (VNF configuration information and internal paths among VNFs used in service chaining) that is transmitted from upper apparatuses such as the orchestrator 202, the uCPE-PF controller 201, and the VNF controller 203 in the data center 20 to VNFs, etc. operating on the uCPE apparatus 100. The uCPE apparatus stores the above setting information transmitted from the upper apparatuses to the VNFs, etc. in the storage part (not illustrated) and analyzes the setting information to acquire the VNF configuration information and information about the internal paths among the VNFs used in the service chaining.

When a fault occurs in a uCPE apparatus 100, the uCPE apparatus 100 analyzes a fault notification (a management signal) to be transmitted from the uCPE apparatus 100 to the upper apparatus and grasps content of the fault. The uCPE apparatus 100 may be configured to detect a fault about a logical port, etc. of a VNF implemented as a virtual machine (VM) on the NFVI (NFV Infrastructure) of the uCPE apparatus 100 and a fault about a hardware platform and/or a software platform of the uCPE apparatus 100, for example.

After grasping the fault, the uCPE apparatus 100 performs recovery from the fault by deriving (calculating) service chaining that bypasses a location (for example, a VNF) in which the fault has occurred and rearranging the service chaining, based on the VNF configuration information and service chaining information stored in the uCPE apparatus 100.

After the recovery from the fault, the uCPE apparatus 100 transmits a setting change notification, for example, about the internal paths among the VNFs used in the service chaining to the upper apparatus(es) (the VNF controller 203, the orchestrator 202, etc.) and requests the upper apparatus(es) to update the setting information managed by the upper apparatus(es). As a result, it is made possible that there is no difference generated regarding setting information about VNFs between the upper apparatus (the VNF controller 203, the orchestrator 202, etc.) and the uCPE apparatus 100.

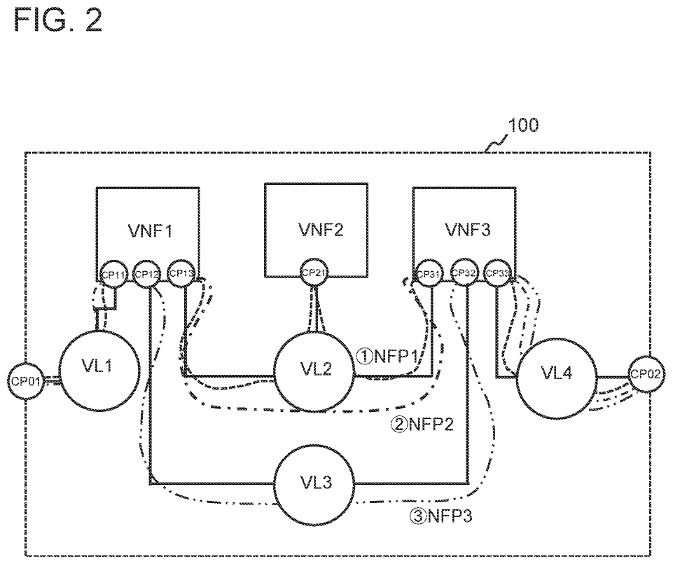

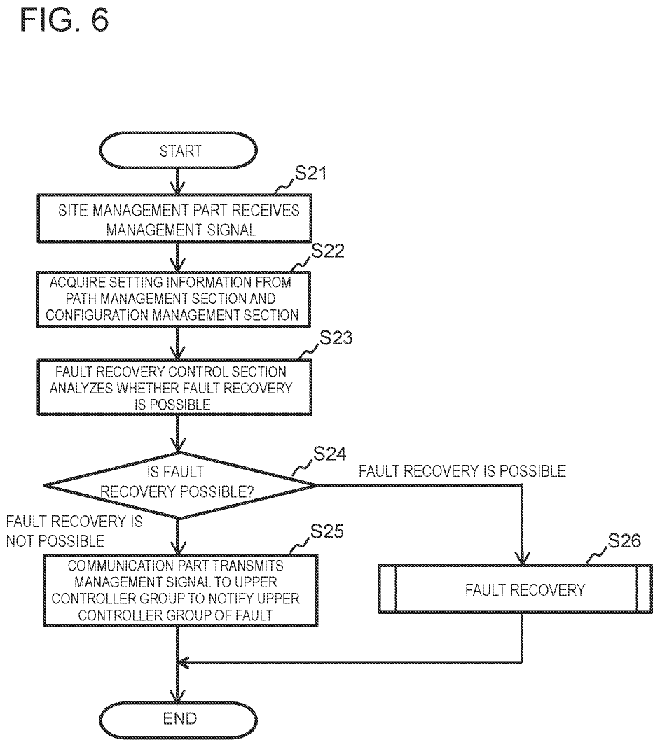

FIG. 2 is a diagram illustrating an example of change of service chaining. FIG. 2 is a diagram based on FIG. 6.5 in ETSI GS NFV-MAN 001 V1.1.1 (2014-12) Network Functions Virtualisation (NFV); Management and Orchestration. In FIG. 2, service chaining, which connects VNFs on the uCPE apparatus 100, is configured by a virtual link VL1, a VNF1, a virtual link VL2, a VNF2, a VNF3, and a virtual link VL4. A dashed line in FIG. 2 represents an NFP (Network Forwarding Path) 1. Such an NFP is managed by a VNFFGR (VNF Forwarding Graph Record) (an instance record), for example. In FIG. 2, the NFP1 is configured by the virtual link VL1 from a network service endpoint (connection point) CP01 to a connection point CP11 of the VNF1, the virtual link VL2 between a connection point CP13 of the VNF1 and a connection point CP21 of the VNF2, the virtual link VL2 between the connection point CP21 of the VNF2 and a connection point CP31 of the VNF3, and the virtual link VL4 between a connection point CP33 of the VNF3 and the network service endpoint (a connection point CP02). When detecting a fault of the connection point CP21 of the VNF2, the uCPE apparatus 100 may refer to a VNFFGD (VNF Forwarding Graph Descriptor), a VNFFGR, information elements of the NFPs, a customer service agreement (contract), etc. and switch the NFP1 to a path NFP2 that bypasses the VNF2. Alternatively, the uCPE apparatus 100 may switches the NFP1 to a path NFP3 that bypasses the VNF2. In this case, the uCPE apparatus 100 may gracefully or forcefully terminate the VNF2. Alternatively, if the VNF2 has a redundancy configuration, the uCPE apparatus 100 may perform auto healing to switch the faulty active VNF to a standby VNF.

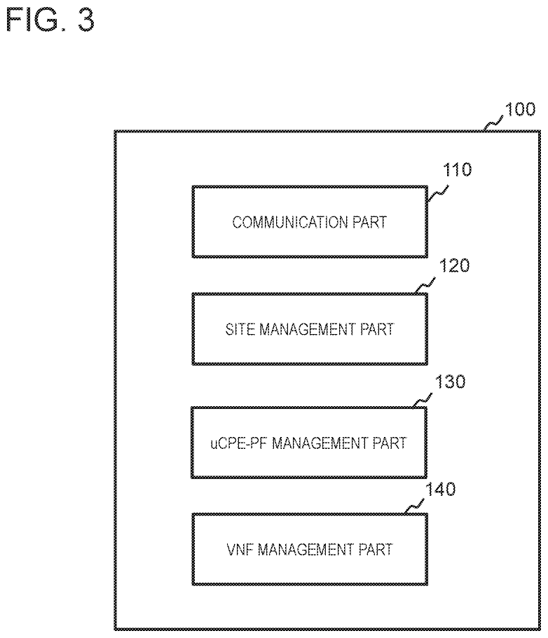

FIG. 3 is a diagram illustrating a configuration of a uCPE apparatus 100. As illustrated in FIG. 3, the uCPE apparatus 100 includes a communication part 110, a site management part 120, a uCPE-PF management part 130, and a VNF management part 140.

The communication part 110 in the uCPE apparatus 100 includes an interface (network interface) not illustrated that communicates with the uCPE-PF controller 201, the VNF controller 203, etc. in the data center 20 via the WAN 30.

The site management part 120 mediates a control signal between the uCPE-PF management part 130 or the VNF management part 140 and the upper apparatuses such as the uCPE-PF controller 201 and the VNF controller 203 in the data center 20, extracts setting information from the control signal, and stores the setting information in a storage part not illustrated.

In addition, other than the control signal, the site management part 120 also mediates a management signal (for example, an SNMP (Simple Network Management Protocol) trap (SNMP agent transmits a change that occurs in an SNMP agent system to an SNMP manager as an SNMP trap) or a log). When fault information is included in a management signal, the site management part 120 determines whether fault recovery processing is possible based on stored setting information. If the site management part 120 determines that fault recovery processing is possible, in place of the upper apparatuses, the site management part 120 gives a service chaining switching instruction to the uCPE-PF management part 130 and the VNF management part 140.

The uCPE-PF management part 130 manages virtual machines (VMs) for implementing VNFs on the uCPE apparatus 100, manages internal paths among VNFs for service chaining. The uCPE-PF management part 130 is controlled by the uCPE-PF controller 201, which is an upper apparatus.

The VNF management part 140 manages a VNF(s) deployed on a virtual machine(s) (VM(s)) created by the uCPE-PF management part 130. The VNF management part 140 is controlled by the VNF controller 203, which is an upper apparatus.

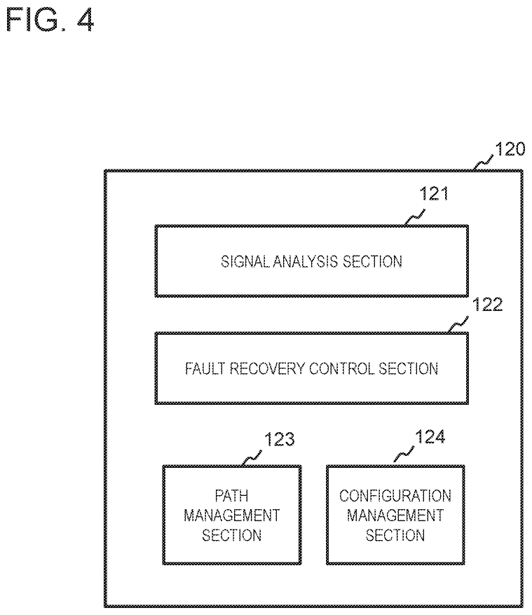

FIG. 4 is a diagram illustrating a configuration of the site management part 120 in FIG. 3. As illustrated in FIG. 4, the site management part 120 includes a signal analysis section 121, a fault recovery control section 122, a path management section 123, and a configuration management section 124.

The signal analysis section 121 mediates control and management signals. When mediating a control signal, the signal analysis section 121 instructs the path management section 123 or the configuration management section 124 to store corresponding setting information. When mediating a management signal, the signal analysis section 121 gives a notification to the fault recovery control section 122.

The fault recovery control section 122 receives the notification from the signal analysis section 121 and determines whether a fault has occurred. If the fault recovery control section 122 determines that a fault has occurred, the fault recovery control section 122 acquires the setting information stored in the path management section 123 or the configuration management section 124 and calculates service chaining for fault recovery.

When the fault recovery control section 122 determines that the fault recovery processing is possible, the fault recovery control section 122 gives a setting change instruction to the uCPE-PF management part 130 or the VNF management part 140. After the uCPE-PF management part 130 or the VNF management part 140 completes setting change, the fault recovery control section 122 transmits a notification of change of the setting to the upper apparatuses such as the uCPE-PF controller 201, the VNF controller 203, etc.

Based on an instruction from the signal analysis section 121, the path management section 123 stores internal path information about service chaining in a storage part (not illustrated). When receiving a setting information acquisition request from the fault recovery control section 122, the path management section 123 transfers the internal path information stored in the storage part (not illustrated) to the fault recovery control section 122.

As with the path management section 123, the configuration management section 124 stores and transfers information about kinds of the VNFs implemented on the uCPE apparatus 100 and the virtual ports used in service chaining.

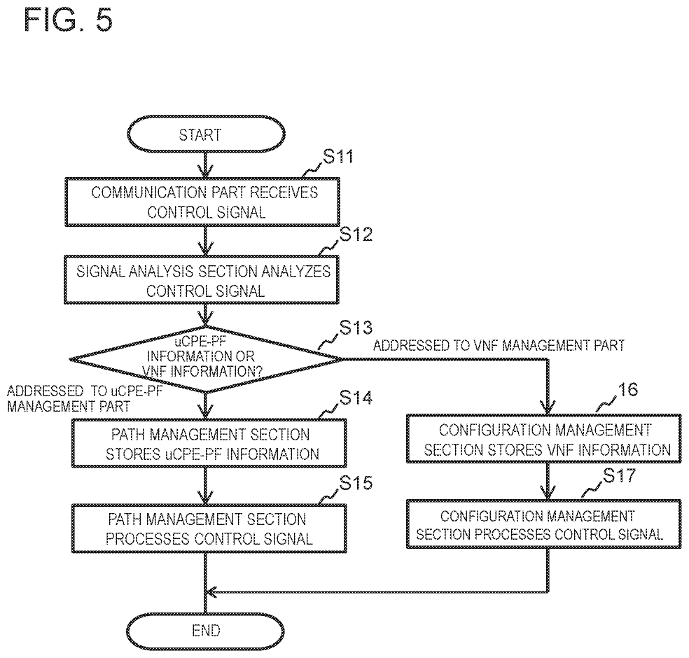

FIG. 5 is a flowchart illustrating an operation according to the example embodiment of the present invention.

### <Step S11>

After receiving a control signal from an upper apparatus (the uCPE-PF controller 201 or the VNF controller 203), the communication part 110 in the uCPE apparatus 100 transfers the control signal to the uCPE-PF management part 130 or the VNF management part 140, depending on the control content. Next, the communication part 110 transfers the control signal to the site management part 120.

### <Step S12>

Upon reception of the control signal, the signal analysis section 121 of the site management part 120 analyzes the control signal.

### <Step S13>

When a result of the analysis in step S12 indicates that the control signal is a control signal relating to service chaining addressed to the uCPE-PF management part 130, the signal analysis section 121 forwards the control signal to the path management section 123, to cause the path management section 123 to store setting information. Next, the processing proceeds to step S14. If the result of the analysis in step S12 indicates that the control signal is a control signal about a VNF, the signal analysis section 121 forwards the control signal to the configuration management section 124, to cause the configuration management section 124 to store setting information. Next, the processing proceeds to step S16.

### <Step S14>

Upon reception of the control signal (a control signal relating to service chaining addressed to the uCPE-PF management part 130), the path management section 123 internally stores information about service-chaining-related internal paths in the uCPE apparatus 100 (path information about physical ports, logical ports, virtual switches, etc.) in a storage part.

### <Step S15>

After storing the internal path information, the path management section 123 forwards the control signal to the uCPE-PF management part 130, which is originally a destination, which updates the uCPE-PF (uCPE platform) setting information.

### <Step S16>

Upon reception of the control signal (a control signal about a VNF), the configuration management section 124 stores information about a kind of the VNF, virtual ports used for the service chaining, etc. in a storage part (not illustrated).

### <Step S17>

After storing the information about the kind of the VNF, the virtual ports, etc., the configuration management section 124 forwards the control signal to the VNF management part 140, which is originally a destination. The VNF management part 140 updates the VNF setting information stored in the storage part.

FIG. 6 illustrates a fault recovery operation according to the example embodiment of the present invention.

### <Step S21>

When the communication part 110 in the uCPE apparatus 100 receives a management signal, which is to be transmitted to the upper apparatus (the uCPE-PF controller 201 and/or the VNF controller 203), from the CPE-PF management part 130 and the VNF management part 140, the communication part 110 forwards the management signal to the site management part 120, before transmitting the management signal to the upper apparatus(es).

### <Step S22>

When the site management part 120 receives the management signal, the fault recovery control section 122 acquires service-chaining-related setting information used to analyze whether fault recovery processing is possible, from the path management section 123 and the configuration management section 124.

### <Step S23>

The fault recovery control section 122 performs analysis to determine whether a fault has occurred, based on the management signal. Next, if the fault recovery control section 122 determines that a fault has occurred, the fault recovery control section 122 determines whether reconfiguration of the service chaining, which bypasses the fault occurrence location and enables fault recovery, is possible, based on the various setting information acquired in step S22.

### <Step S24>

The fault recovery control section 122, as a result of the analysis in step S23, when determining that fault recovery is possible by rearranging the service chaining, performs fault recovery processing in step S26. When the fault recovery control section 122 determines that changing the service chaining will not achieve fault recovery, the processing proceeds to step S25 in which the fault recovery control section 122 transmits a fault notification to the upper apparatuses.

### <Step S25>

A fault notification to mean that the fault recovery is not possible and the fault is confirmed, is performed from the communication part 110 of the uCPE apparatus 100 to the upper apparatuses (the uCPE-PF controller 201, the VNF controller 203, etc.). There is a case where the uCPE apparatus 100 cannot recover a fault by changing the service chaining. For example, when there is a fault in a hardware apparatus, a network failure or the like, a fault notification may be transmitted to the upper apparatus (e.g., the uCPE-PF controller 201), and necessary maintenance and recovery measures may be performed on the uCPE apparatus 100. A recovery completion notification may be transmitted to the upper apparatus(es).

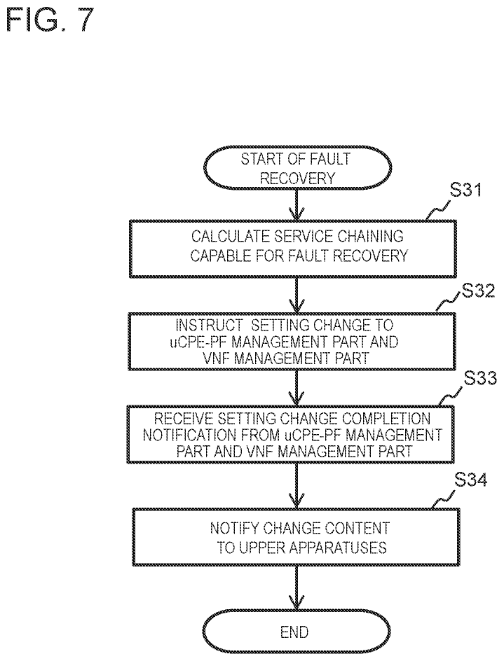

FIG. 7 is a diagram illustrating details of an operation (step S26 in FIG. 6) of the fault recovery control section 122 according to the example embodiment of the present invention.

### <Step S31>

The fault recovery control section 122 calculates service chaining that bypasses the fault occurrence location and calculates a setting to change to the service chaining calculated.

### <Step S32>

The fault recovery control section 122 sends a setting change instruction about the setting calculated in step S31 to the uCPE-PF management part 130 and the VNF management part 140, to rearrange the service chaining.

### <Step S33>

When receiving a setting change completion notification from the uCPE-PF management part 130 and the VNF management part 140, the fault recovery control section 122 determines that the setting change has been completed. Next, the processing proceeds to step S34 in which a setting change notification is transmitted to the upper apparatuses (the uCPE-PF controller 201 and the VNF controller 203).

### <Step S34>

The setting change operation performed by the fault recovery control section 122, generates a difference between the setting information held by the uCPE-PF management part 130 and the VNF management part 140 and the corresponding setting contents held by the upper apparatuses (the uCPE-PF controller 201 and the VNF controller 203). The fault recovery control section 122 transmits a setting change notification to respective upper apparatuses (the uCPE-PF controller 201 and the VNF controller 203), to control so that such difference will not be caused between the setting contents in the respective upper apparatuses (the uCPE-PF controller 201 and the VNF controller 203) and the actual setting contents.

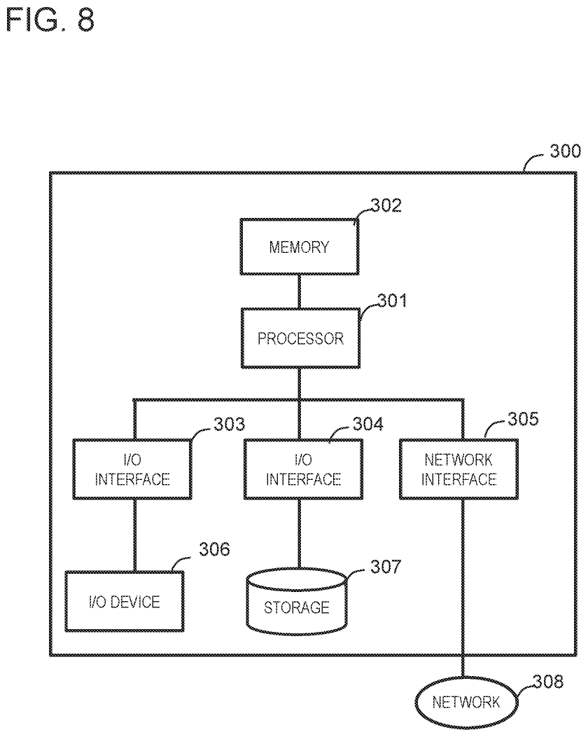

FIG. 8 is a diagram illustrating another example embodiment of the present invention. FIG. 8 is a diagram illustrating an example in which a uCPE apparatus 100 is implemented by a computer. As illustrated in FIG. 8, a computer 300 includes a processor 301, a memory 302 such as a DRAM (Dynamic Random Access Memory), an SRAM (Static Random Access Memory), or an EEPROM (Electrically Erasable Programmable Read-Only Memory), I/O (Input/Output) interfaces 303 and 304, and a network interface 305. The I/O interface 303 is connected to an I/O device 306, and the I/O interface 304 is connected to a storage 307. The network interface 305 is connected to a network such as the WAN 30 in FIG. 1 and communicates with the uCPE-PF controller 201, the VNF controller 203, etc. in the data center 20. For example, by causing the processor 301 to execute a program (instructions) stored in the memory 302, the computer 300 implements processing and functions of the uCPE apparatus 100 according to the above example embodiment.

As described above, calculation and setting of service chaining configured by a plurality of VNFs under a predetermined condition and in a predetermined order are originally performed in accordance with an instruction from an orchestrator that manages the corresponding lifecycle. However, due to a geographical distance between a uCPE apparatus in an individual site and the orchestrator and a load status of a control system, it takes time for a change of a setting of a service chaining to be reflected on the uCPE apparatus and a service down-time, etc., could be prolonged. Even in this situation, the above example embodiments can reduce the service down-time by implementing the site management part (120 in FIG. 3), which is a mechanism having a part (VNF management function and service chaining change function) of the functions of the orchestrator and a controller, on the uCPE apparatus (100 in FIG. 3).

In the above example embodiments, instead of performing control of the individual uCPE apparatus in an individual site only from the upper apparatus such as a controller in a data center, part of recovery control processing is autonomously and locally performed in the uCPE apparatus. The internal configuration and control method of the uCPE apparatus is not, as a matter of course, limited to what has been described in the above example embodiments. For example, the following modification or addition may be made to the configuration and control method described in the above example embodiments, as needed.
Service chaining may be configured as a template, and changing the service chaining may be simplified by sharing the template with an orchestrator, without grasping details of the setting information. The template of the service chaining may be a data file in which selection of VNFs implemented on an individual uCPE apparatus and implementation order of VNFs are described in a patterned format, for example.
Instead of mediating the control signal by the site management part 120 in the individual uCPE apparatus 100 to store the setting information, the control signal may be forwarded to both of the path management section 123 and the configuration management section 124.
As one fault recovery means, a VNF reset function, etc. may be added. For example, instead of bypassing a faulty VNF, initialization, restarting or the like of the faulty VNF may be performed. Depending on a fault, by restarting a virtual machine (VM) on which the faulty VNF operates as an application, the fault could be recovered, and a normal operation could be performed. Since the reset operation of a faulty VNF can be deemed as changing setting of a state of the VNF, the reset operation can, as a matter of course, be included in the service chaining change operation.
In the individual uCPE apparatus, a common management part for managing setting information about paths of service chaining, configurations of VNFs, etc. may be used.

The present invention is applicable to, for example, hardware equipment such as a server and a network appliance in a virtualized environment, and provision of service using the hardware equipment.

The disclosure of PTL 1 cited above is incorporated herein in its entirety by reference thereto. It is to be noted that it is possible to modify or adjust the example embodiments or examples within the whole disclosure of the present invention (including the Claims) and based on the basic technical concept thereof. Further, it is possible to variously combine or select (or partially delete) a wide variety of the disclosed elements (including the individual elements of the individual claims, the individual elements of the individual example embodiments or examples, and the individual elements of the individual figures) within the scope of the disclosure of the present invention. That is, it is self-explanatory that the present invention includes any types of variations and modifications to be done by a skilled person according to the whole disclosure including the Claims, and the technical concept of the present invention. Particularly, any numerical ranges disclosed herein should be interpreted that any intermediate values or subranges falling within the disclosed ranges are also concretely disclosed even without specific recital thereof.

### REFERENCE SIGNS LIST

10A, 10B site
20 data center
30 WAN
100, 100A, 100B uCPE apparatus
101, 101A, 101B server group
110 communication part
120 site management part
121 signal analysis section
122 fault recovery control section
123 path management section
124 configuration management section
130 uCPE-PF management part
140 VNF management part
201 uCPE-PF controller
202 orchestrator
203 VNF controller
300 computer
301 processor
302 memory
303, 304 I/O interface
305 network interface
306 input/output device
307 storage
308 network

What is claimed is:

1. A fault recovery control method for a communication apparatus in a communication system, wherein the communication system comprises: the communication apparatus that is arranged in a site and includes a plurality of virtual network functions used for service chaining; and at least one upper apparatus that is connected to the communication apparatus in the site via a network and manages the virtual network functions and the service chaining on the communication apparatus, the method comprising:
setting, at least a part of functions of the upper apparatus for changing the service chaining on the communication apparatus in the site, to be deployed on the communication apparatus in the site; and
on occurrence of a fault in the communication apparatus in the site, the communication apparatus rearranging autonomously the service chaining thereon to perform recovery from the fault.

2. The fault recovery control method according to claim 1, comprising
the communication apparatus, after recovery from the fault, transmitting a notification of change in setting of the service chaining to the upper apparatus.

3. The fault recovery control method according to claim 1, comprising
on occurrence of a fault in the communication apparatus, if the communication apparatus determines that autonomous fault recovery is possible by rearranging the service chaining based on setting information about configurations and paths of the virtual network functions used for the service chaining, wherein the setting information is stored in the communication apparatus,
the communication apparatus rearranging the service chaining, without receiving an instruction from the upper apparatus.

4. The fault recovery control method according to claim 3, comprising
the communication apparatus acquiring setting information about paths of the service chaining and setting information about a configuration of individual one of the virtual network functions, from a control signal transmitted from the upper apparatus to the communication apparatus.

5. A communication system, comprising:
a communication apparatus arranged in a site, the communication apparatus including a plurality of virtual network functions and a service chaining with the virtual network functions connected; and
at least one upper apparatus connected to the communication apparatus via a network, the upper apparatus managing the virtual network functions and the service chaining on the communication apparatus,
wherein the communication apparatus comprises:
a processor; and
a memory in circuit communication with the processor and storing program instruction executable by the processor, wherein the processor is configured to
change the service chaining on the communication apparatus,
wherein the processor, on occurrence of a fault in the communication apparatus, rearranges the service chaining to perform recovery from the fault.

6. The communication system according to claim 5, wherein the processor in the communication apparatus, after recovery from the fault, transmits a notification of change in setting of the service chaining to the upper apparatus.

7. The communication system according to claim 5, wherein the communication apparatus includes
a storage part that stores setting information about configurations and paths of the virtual network functions used for the service chaining,
wherein, on occurrence of a fault in the communication apparatus, the processor determines whether an autonomous fault recovery, in which the service chaining is rearranged based on the setting information stored in the storage part, is possible, and
wherein, when determining that the autonomous fault recovery is possible, the processor rearranges the service chaining, without receiving an instruction from the upper apparatus.

8. A communication apparatus arranged in a site and including a plurality of virtual network functions and service chaining with the virtual network functions connected, wherein the communication apparatus is connected to at least one upper apparatus that manages the virtual network functions and the service chaining on the communication apparatus via a network, the communication apparatus comprising:
a processor;
a memory in circuit communication with the processor and storing program instruction executable by the processor; and
a storage part that stores setting information about the service chaining connecting the virtual network functions,
wherein the processor is configured to, on occurrence of a fault in the communication apparatus, change the service chaining, based on the setting information stored in the storage part to perform recovery from the fault.

9. The communication apparatus according to claim 8, wherein the processor is configured to, after recovery from the fault, transmit a notification of change in setting of the service chaining to the upper apparatus.

10. (canceled)

11. The fault recovery control method according to claim 1, comprising
on occurrence of a fault in the virtual network function used for the service chaining,
the communication apparatus changing autonomously the service chaining by
rearranging paths among the virtual network functions used for the service chaining to bypass the virtual network function on which the fault occurs, or by resetting the virtual network function on which the fault occurs, based on setting information about configurations and the paths of the virtual network functions used for the service chaining.

12. The fault recovery control method according to claim 1, wherein the upper apparatus is at least one of a virtual network function controller that controls the virtual network functions on the communication apparatus in an individual site, and a network function virtualization orchestrator that coordinates at least the virtual network function controller to provide a network service.

13. The communication system according to claim 7, wherein the processor in the communication apparatus is configured to acquire setting information about paths of the service chaining and setting information about a configuration of individual one of the virtual network functions, from a control signal transmitted from the upper apparatus to the communication apparatus.

14. The communication system according to claim 5, wherein
the processor in the communication apparatus is configured to, on occurrence of a fault in the virtual network function used for the service chaining on the communication apparatus, change autonomously the service chaining by rearranging paths among the virtual network functions used for the service chaining to bypass the virtual network function on which the fault occurs, or by resetting the virtual network function on which the fault occurs, based on setting information about a configuration and the paths of the virtual network functions used for the service chaining.

15. The communication system according to claim 5, wherein the upper apparatus is at least one of a virtual network function controller that sets and controls the virtual network functions on the communication apparatus in an individual site, and a network function virtualization orchestrator that coordinates at least the virtual network function controller to provide a network service.

16. The communication apparatus according to claim 8, wherein
the processor is configured to, on occurrence of a fault in the communication apparatus, determine whether an autonomous fault recovery, in which the service chaining is rearranged based on the setting information stored in the storage part, is possible, and
wherein, when determining that the autonomous fault recovery is possible, the processor is configured to rearrange the service chaining, without receiving an instruction from the upper apparatus.

17. The communication apparatus according to claim 16, wherein the processor is configured to acquire setting information about paths of the service chaining and setting information about a configuration of individual one of the virtual network functions, from a control signal transmitted from the upper apparatus to the communication apparatus.

18. The communication apparatus according to claim 8, wherein the processor is configured to, on occurrence of a fault in the virtual network function used for the service chaining on the communication apparatus, change autonomously the service chaining by rearranging paths among the virtual network functions used for the service chaining to bypass the virtual network function on which the fault occurs, or by resetting the virtual network function on which the fault occurs, based on setting information about a configuration and the paths of the virtual network functions used for the service chaining.

19. The communication apparatus according to claim 8, wherein the upper apparatus is at least one of a virtual network function controller that controls the virtual network functions on the communication apparatus in an individual site, and a network function virtualization orchestrator that coordinates at least the virtual network function controller to provide a network service.

20. The communication apparatus according to claim 19, wherein the virtual network function on the communication apparatus cause the communication apparatus to operate as a Universal Customer Premises Equipment (uCPE) in an enterprise branch site, and wherein the upper apparatus is deployed in a data center.
